(19) United States
(12) Patent Application Publication
(10) Pub. No.: US 2013/0254575 A1
(43) Pub. Date: Sep. 26, 2013

(54) ELECTRONIC DEVICE HAVING MEMORIES AND METHOD FOR MANAGING MEMORIES THEREOF

(71) Applicant: FA-SHENG HUANG, Shenzhen City (CN)

(72) Inventor: FA-SHENG HUANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/592,362

(22) Filed: Aug. 23, 2012

(30) Foreign Application Priority Data
Mar. 26, 2012 (CN) 201210082528.9

(51) Int. Cl. G06F 1/32

(52) U.S. Cl. 713/324

(57) ABSTRACT

A method for managing memories in an electronic device includes the following steps. Detecting a change in status of all the applications installed in the electronic device, wherein the change in status of each application may include at least one start-to-run application or at least one stop-running application. If the at least one stop-running application is detected, obtaining memories occupied by the stop-running application, and powering off each obtained memory occupied by other running application. If the at least one start-to-run application is detected, determining a memory size required to enable each start-to-run application to run, determining whether a working condition of the memories needs to be changed according to the determined memory size required, and powering on the memories that are needed to enable the start-to-run application to run.

### BACKGROUND

1. Technical Field

The present disclosure relates to electronic devices, and particularly to an electronic device capable of managing memories thereof and a method adapted for the electronic device.

2. Description of Related Art

Electronic devices, such as computers or servers, will have a number of memories. When applications installed in an electronic device start to run, memories with a sufficient storage capacity for running the applications is needed. A portion of the number of memories are idle when a few applications are currently running, but the electronic device still powers on all the memories regardless of whether there are idle memories, so wasting power of the electronic device.

Therefore, what is needed is a means to solve the problem described above.

### BRIEF DESCRIPTION OF THE DRAWINGS

Many aspects of the present disclosure can be better understood with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a block diagram of an electronic device capable of managing memories, in accordance with an exemplary embodiment.

FIG. 2 is a flowchart of a method for managing memories, in accordance with an exemplary embodiment.

FIG. 3 is a detailed illustration in step S26 of the flowchart of FIG. 2, of a determination of whether a working condition of the memories needed to be changed.

### DETAILED DESCRIPTION

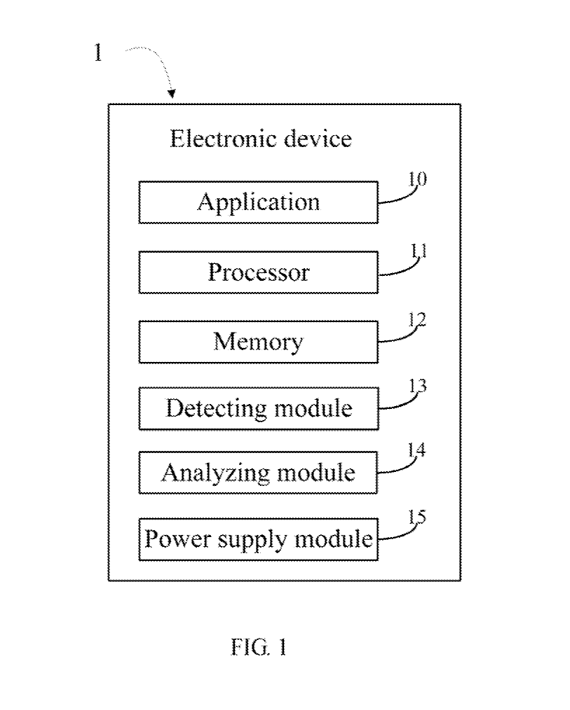

FIG. 1 is a block diagram of an electronic device 1 according to an exemplary embodiment. The electronic device 1, such as a computer or a server, includes a variety of applications 10 and a variety of memories 12 configured to enable the applications 10 to run. The electronic device 1 further includes a processor 11 and a variety of modules executed by the processor 11 to provide the functions of the electronic device 1.

In the embodiment, the variety of modules includes a detecting module 13, an analyzing module 14, and a power supply module 15.

The detecting module 13 detects a change in status of all the applications 10 in the electronic device 1, and the change in status of at least one application 10 may be that it starts to run (hereafter “start-to-run application”) or that it stops running (hereafter “stop-running application”).

When detecting at least one stop-running application 10, the analyzing module 14 obtains the memories 12 occupied by the stop-running application, and determines whether each obtained memory 12 is occupied by any other running application 10. If one obtained memory 12 is not occupied by any other running application, the power supply module 15 stops supplying power to the memory 12. Otherwise, if one obtained memory 12 is occupied by another running application, the power supply module 15 does not stop power to the obtained memories 12.

When detecting at least one start-to-run application, the detecting module 13 determines a memory size required to run the start-to-run application. The analyzing module 14 determines whether the working condition of the memories 12 needs to be changed according to the memory size determined by the detecting module 13. The working conditions of the memories 12 includes an idle condition in which the memory 12 is not working (hereafter “idle memory”) and a working condition in which the memory 12 is already utilized and working (hereafter “working memory”). If yes to the idle memory state, the power supply module 15 powers on the idle memory that is needed to run the start-to-run application.

In the embodiment, when at least one start-to-run application is detected, the detecting module 13 determines a memory size sufficient to enable the running of the start-to-run application (referred as “to-be-occupied memory size” thereinafter), and obtains at least one idle memory with a storage capacity of not less than the to-be-occupied memory size of the start-to-run application, such as a storage capacity equal to the determined occupied memory size in one embodiment. Then, the power supply module 15 powers on the obtained idle memory. Taking an electronic device 1 including six memories 12 and each memory 12 having a storage capacity of not less than 2G for example, if four memories 12 are idle in the electronic device 1 before a change in status of any of the applications 10 is detected, and an application 10 requires a memory size of 2G to run, the analyzing module 14 determines that only one of the four idle memories 12 needs to be powered on to enable the application 10 to run.

In an alternative embodiment, when at least one start-to-run application is detected, the analyzing module 14 may determine the to-be-occupied memory size of the start-to-run application, obtain a proportion of the capacity of each working memory which is being used, calculate a total free capacity of the working memories based on the obtained capacity being used, and then compare the to-be-occupied memory size of the start-to-run application with the total free capacity. If the to-be-occupied memory size of the start-to-run application is not more than the total free capacity, the power supply module 15 may maintain the working condition of the memories 12; otherwise, the analyzing module 14 may calculate the difference between the to-be-occupied memory size of the start-to-run application and the total free capacity, and then obtain at least one idle memory with a storage capacity of not less than the calculated difference, such as a storage capacity equal to the calculated difference in one embodiment. Then, the power supply module 15 powers on the obtained idle memory. In the example mentioned above, the start-to-run application 10 required a memory size of 2G to run; if the capacity of each of the two working memories which are being used is 50%, then the analyzing module 14 determines a total free capacity of all the working memories to be 2G, and also determines that the total free capacity of 2G is sufficient to enable the start-to-run application 10 to run. Thus, the power supply module 15 maintains the working condition of the memories 12.

More specifically, when at least one start-to-run application and at least one stop-running application are simultaneously detected, the detecting module 13 determines the to-be-occupied memory size of the start-to-run application and the memory size of the stop-running application (referred as “to-be-released memory size” thereinafter). Then, the analyzing module 14 compares the to-be-occupied memory size with the to-be-released memory size. If the to-be-occupied memory size is greater than the to-be-released memory size, the analyzing module 14 further calculates the difference between the to-be-occupied memory size and the to-be-released memory size, and obtains at least one idle memory 12 with a storage capacity of not less than the calculated difference, such as a storage capacity equal to the calculated difference in one embodiment, and the power supply module 15 accordingly powers on the obtained memory 12. If the to-be-occupied memory size is equal to or is less than the to-be-released memory size, the power supply module 15 maintains the working condition of the memories 12.

Therefore, the electronic device 1 can selectively power on and power off the memories 12 as conditions require or allow, thus the power consumption of the electronic device 1 is significantly reduced.

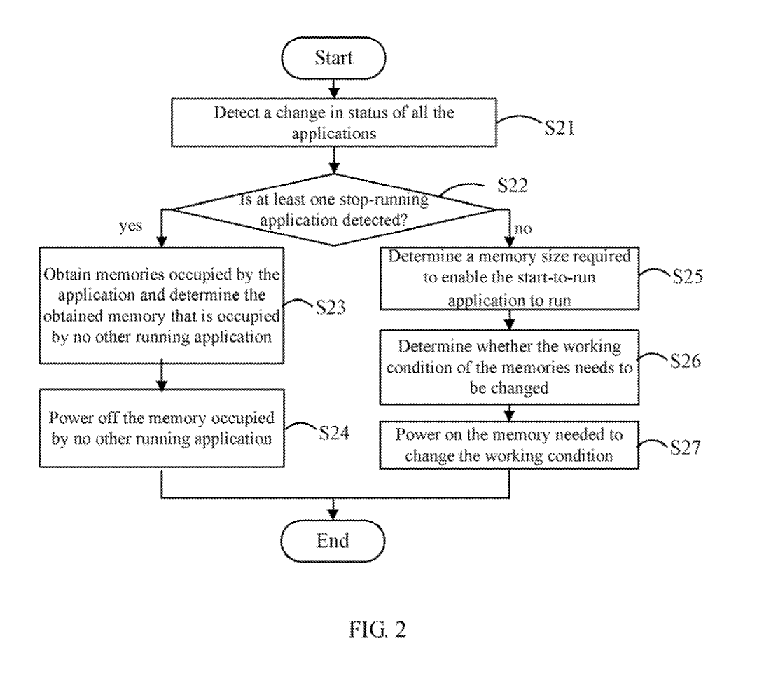

FIG. 2 is a flowchart of a method for managing memories 12 installed in an electronic device 1, in accordance with an exemplary embodiment.

In step S21, the detecting module 13 detects a change in status of all the applications 10 installed in the electronic device 1.

In step S22, the analyzing module 14 analyzes the result from the detecting module 13, and if at least one stop-running application is detected, the procedure goes to step S23; otherwise, if at least one start-to-run application is detected, the procedure goes to step S25.

In step S23, the analyzing module 14 obtains the memories 12 occupied by the stop-running application, and determines the obtained memory 12 that is occupied by no other running application 10.

In step S24, the power supply module 15 powers off the determined memory 12.

In step S25, the detecting module 13 determines a memory size required to enable the start-to-run application to run.

In step S26, the analyzing module 14 determines whether the working condition of the memories 12 of the electronic device 1 needs to be changed according to the determined memory size, if yes, the procedure goes to step S27; otherwise, the procedure goes back to step S21.

In step S27, the power supply module 15 powers on an idle memory that needed to change the working condition, to enable a start-to-run application to run.

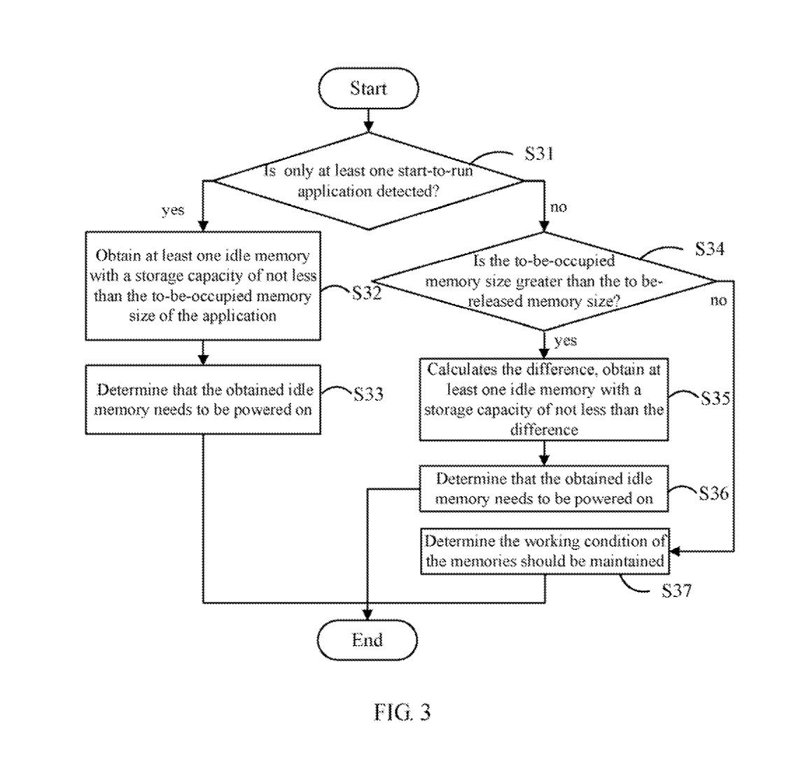

FIG. 3 is a flowchart of an exemplary embodiment of a determination of whether or not the working condition of the memories 12 needs to be changed, in step S26 in FIG. 2.

In step S31, the analyzing module 14 further analyzes the result from the detecting module 13, and if only at least one start-to-run application, and no other event, is detected, the procedure goes to step S32; otherwise, if at least one start-to-run application and another event, such as at least one stop application, are simultaneously detected, the procedure goes to step S34.

In step S32, the analyzing module 14 obtains from the detecting module 13 at least one idle memory with a storage capacity of not less than the to-be-occupied memory size of the start-to-run application.

In step S33, the analyzing module 14 determines that the obtained idle memory needs to be powered on.

In step S34, the analyzing module 14 compares the to-be-occupied memory size of the start-to-run application with the to-be-released memory size of the stop-running application detected by the detecting module 13, and if the to-be-occupied memory size is greater than the to-be-released memory size, the procedure goes to step S35; otherwise, the procedure goes to step S37.

In step S35, the analyzing module 14 calculates the difference between the to-be-occupied memory size and the to-be-released memory size, and obtains at least one idle memory with a storage capacity of not less than the calculated difference.

In step S36, the analyzing module 14 determines that the obtained idle memory needs to be powered on.

In step S37, the analyzing module 14 determines that the working condition of the memories 12 should be maintained.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device comprising:
a plurality of memories;
a plurality of applications;
a processor; and
a plurality of modules to be executed by the processor, the plurality of modules comprising:
a detecting module to detect a change in status of all the applications, wherein the change in status of the applications comprises at least one start-to-run application of the plurality of applications or at least one stop-running application of the plurality of applications; and the detecting module further to determine a memory size required to enable each start-to-run application to run if at least one start-to-run application is detected;
an analyzing module configured to:
obtain memories of the plurality of memories occupied by the at least one stop-running application if the at least one stop-running application is detected, and determine whether each obtained memory is occupied by any other running application; and
determine whether a working condition of the memories needs to be changed according to the determined memory size, if the at least one start-to-run application is detected; and
a power supply module configured to:
stop supplying power to the obtained memory only occupied by the at least one stop-running application; and
power on the memories that needed to change the working condition to enable the at least one start-to-run application to run.

2. The electronic device of claim 1, wherein if at least one start-to-run application is detected, the analyzing module further determines a memory size sufficient to run the start-to-run application, and obtains at least one idle memory with a storage capacity of not less than the determined occupied memory size; and then the power supply module powers on the obtained idle memory.

3. The electronic device of claim 2, wherein the analyzing module obtains an idle memory with a storage capacity equal to the determined occupied memory size.

4. The electronic device of claim 1, wherein if at least one start-to-run application is detected, the analyzing module determines a memory size required for the start-to-run application, obtains a proportion of the capacity of each working memory which is being used, calculates a total free capacity of the working memories based on the obtained capacity being used, and then compares the determined memory size with the total free capacity; if the determined memory size is not more than the total free capacity, the power supply module maintains the working condition of the memories; if the determined memory size is less than the total free capacity, the analyzing module calculates a difference between the determined memory size and the total free capacity, and obtains at least one idle memory with a storage capacity of not less than the calculated difference, and then the power supply module powers on the obtained idle memory.

5. The electronic device of claim 1, wherein if at least one start-to-run application and at least one stop-running application are simultaneously detected, the analyzing module compares the memory size to be occupied by the start-to-run application with the memory size to be released by the stop-running application; if the memory size to be occupied by the start-to-run application is greater than the memory size to be released by the stop-running application, the analyzing module calculates a difference between the memories sizes, obtains at least one idle memory with a storage capacity not less than the calculated difference, and then the power supply module powers on the obtained memory; if the memory size to be occupied by the start-to-run application is equal to or less than the memory size to be released by the stop-running application, the power supply module maintains the working condition of the memories.

6. A method for managing memories of an electronic device, the method comprising:
detecting a change in status of all application installed in the electronic device, wherein the change in status of the applications comprises at least one start-to-run application of the plurality of applications or at least one stop-running application of the plurality of applications;
obtaining memories of the plurality of applications occupied by the at least one stop-running application if the at least one stop-running application is detected, determining whether each obtained memory is occupied by any other running application, and stopping supplying power to the obtained memory only occupied by the at least one stop-running application;
determining a memory size required to enable each start-to-run application to run if at least one start-to-run application is detected, determining whether a working condition of the memories needs to be changed according to the determined memory size, and powering on the memories that need to change the working condition to enable the at least one start-to-run application to run.
